(19) United States
(12) Patent Application Publication
(10) Pub. No.: US 2026/0220927 A1
(43) Pub. Date: Jul. 30, 2026

(54) LEARNING MODEL GENERATION DEVICE, LEARNING MODEL GENERATION METHOD, AND COMPUTER-READABLE RECORDING MEDIUM

(71) Applicant: NEC Corporation, Tokyo (JP)

(72) Inventor: Asuka ISHII, Tokyo (JP)

(73) Assignee: NEC Corporation, Tokyo (JP)

(21) Appl. No.: 19/141,475

(22) PCT Filed: Dec. 18, 2023
(86) PCT No.: PCT/JP2023/045336

§ 371 Date: Jun. 20, 2025

(30) Foreign Application Priority Data
Dec. 28, 2022 (JP) 2022-211356

(51) Int. Cl. G06V 10/778; G06V 10/774

(52) U.S. Cl. CPC G06V 10/7796; G06V 10/774

(57) ABSTRACT

A learning model generation device is provided with: a first data input unit that inputs first sample data to a basic learning model that has been trained through machine learning on the relationship between two-dimensional joint point coordinates and three-dimensional joint point coordinates; a second data input unit that inputs second sample data having differences from the first sample data to a learning model to be updated; a difference calculation unit that calculates the difference between an intermediate feature quantity of the basic learning model when the first sample data is input thereto and an intermediate feature quantity of the learning model to be updated when the second sample data is input thereto; and a parameter update unit that uses the calculated difference to update the parameters of the learning model to be updated.

### TECHNICAL FIELD

The present disclosure relates to a learning model generation device and a learning model generation method for generating a learning model for detecting a human joint point, and further relates to a computer-readable recording medium storing a program for implementing the same. The present disclosure relates to a joint point detection device and a joint point detection method for detecting a human joint point, and further relates to a computer-readable recording medium storing a program for implementing the same.

### BACKGROUND ART

In recent years, a technique of estimating human poses by estimating three-dimensional coordinates of each human joint from a two-dimensional image has been developed (for example, refer to PTL 1). Such a technique is expected to be used in the field of image monitoring systems, the field of sports, the field of games, and the like. In such a technique, a learning model is used to detect three-dimensional coordinates of each human joint.

The learning model is constructed by machine learning using, for example, two-dimensional coordinates of each joint (hereinafter referred to as “two-dimensional joint point coordinates”) extracted from a person in an image and three-dimensional coordinates of each joint (hereinafter referred to as “three-dimensional joint point coordinates”) as training data. In the training data, the three-dimensional joint point coordinates correspond to teacher data.

In addition, the machine learning is performed by inputting two-dimensional joint point coordinates serving as training data to the learning model and updating parameters of the learning model such that a difference between the output three-dimensional joint point coordinates and the three-dimensional joint point coordinates serving as teacher data becomes small.

### CITATION LIST

### Patent Literature

PTL 1: JP 2021-47563 A

### SUMMARY OF INVENTION

### Technical Problem

Meanwhile, in machine learning of a conventional learning model, two-dimensional joint point coordinates with less noise such as an error in the position of each joint point are used as training data. This is because, in a case where two-dimensional joint point coordinates with more noise are used as training data, it is not possible to determine whether the data is noise in the learning model, and therefore a learning model with high detection accuracy cannot be constructed.

However, two-dimensional joint point coordinates extracted from an actual two-dimensional image include noise. Therefore, in the conventional learning model, in a case where two-dimensional joint point coordinates extracted from an actual two-dimensional image are used as inputs, it is difficult to detect highly accurate three-dimensional joint point coordinates.

An object of the present disclosure is to improve detection accuracy in estimating three-dimensional coordinates of each joint point from two-dimensional coordinates of each joint.

### Solution to Problem

In order to achieve the above object, a learning model generation device according to an aspect of the present disclosure includes
a first data input unit for inputting first sample data to a basic learning model that has been trained through machine learning on a relationship between two-dimensional joint point coordinates and three-dimensional joint point coordinates,
a second data input unit for inputting second sample data having differences from the first sample data to a learning model to be updated,
a difference calculation unit for calculating a difference between an intermediate feature quantity of the basic learning model when the first sample data is input and an intermediate feature quantity of the learning model to be updated when the second sample data is input, and
a parameter update unit for updating parameters of the learning model to be updated by using the calculated difference.

In order to achieve the above object, a joint point detection device according to another aspect of the present disclosure includes
a joint point detection unit for inputting two-dimensional joint point coordinates of a person to a learning model and detecting three-dimensional joint point coordinates of the person, and
parameters of the learning model are updated using the difference between
intermediate feature quantities when first sample data are input to a basic learning model that has been trained through machine learning on a relationship between two-dimensional joint point coordinates and three-dimensional joint point coordinates, and
intermediate feature quantities when second sample data having differences from the first sample data are input to the learning model.

In order to achieve the above object, a learning model generation method according to still another aspect of the present disclosure includes
a first data input step of inputting first sample data to a basic learning model that has been trained through machine learning on a relationship between two-dimensional joint point coordinates and three-dimensional joint point coordinates,
a second data input step of inputting second sample data having differences from the first sample data to a learning model to be updated,
a difference calculation step of calculating a difference between an intermediate feature quantity of the basic learning model when the first sample data is input and an intermediate feature quantity of the learning model to be updated when the second sample data is input, and
a parameter update step of updating parameters of the learning model to be updated by using the calculated difference.

In order to achieve the above object, a joint point detection method according to still another aspect of the present disclosure includes
a joint point detection step of inputting two-dimensional joint point coordinates of a person to a learning model and detecting three-dimensional joint point coordinates of the person, and
parameters of the learning model are updated using the difference between
intermediate feature quantities when first sample data are input to a basic learning model that has been trained through machine learning on a relationship between two-dimensional joint point coordinates and three-dimensional joint point coordinates, and
intermediate feature quantities when second sample data having differences from the first sample data are input to the learning model.

Furthermore, in order to achieve the above object, a first computer-readable recording medium according to still another aspect of the present disclosure, the recording medium storing a program including instructions that cause a computer to execute
a first data input step of inputting first sample data to a basic learning model that has been trained through machine learning on a relationship between two-dimensional joint point coordinates and three-dimensional joint point coordinates,
a second data input step of inputting second sample data having differences from the first sample data to a learning model to be updated,
a difference calculation step of calculating a difference between an intermediate feature quantity of the basic learning model when the first sample data is input and an intermediate feature quantity of the learning model to be updated when the second sample data is input, and
a parameter update step of updating parameters of the learning model to be updated by using the calculated difference.

Furthermore, in order to achieve the above object, a second computer-readable recording medium according to still another aspect of the present disclosure, the recording medium storing a program including instructions that cause a computer to execute
a joint point detection step of inputting two-dimensional joint point coordinates of a person to a learning model and detecting three-dimensional joint point coordinates of the person, and
parameters of the learning model are updated using the difference between
intermediate feature quantities when first sample data are input to a basic learning model that has been trained through machine learning on a relationship between two-dimensional joint point coordinates and three-dimensional joint point coordinates, and
intermediate feature quantities when second sample data having differences from the first sample data are input to the learning model.

### Advantageous Effects of Invention

As described above, according to the present disclosure, it is possible to improve detection accuracy in estimating three-dimensional coordinates of each joint point from two-dimensional coordinates of each joint.

### BRIEF DESCRIPTION OF DRAWINGS

FIG. 1 is a configuration diagram illustrating a schematic configuration of an example of a learning model generation device.

FIG. 2 is a diagram for describing a function of a basic learning model.

FIG. 3 is a configuration diagram specifically illustrating a configuration of an example of the learning model generation device.

FIG. 4 is an explanatory diagram for describing first sample data and second sample data.

FIG. 5 is a configuration diagram illustrating an example of a configuration of a basic learning model and an update model.

FIG. 6 is a flowchart illustrating an example of an operation of the learning model generation device.

FIG. 7 is a configuration diagram illustrating a configuration of another example of the learning model generation device.

FIG. 8 is a flowchart illustrating another example of the operation of the learning model generation device.

FIG. 9 is a configuration diagram illustrating a configuration of an example of a joint point detection device.

FIG. 10 is a flowchart illustrating an example of an operation of a joint point detection device 50.

FIG. 11 is a block diagram illustrating an example of a computer that implements a learning model generation device and a joint point detection device.

### EXAMPLE EMBODIMENT

### Example Embodiment 1

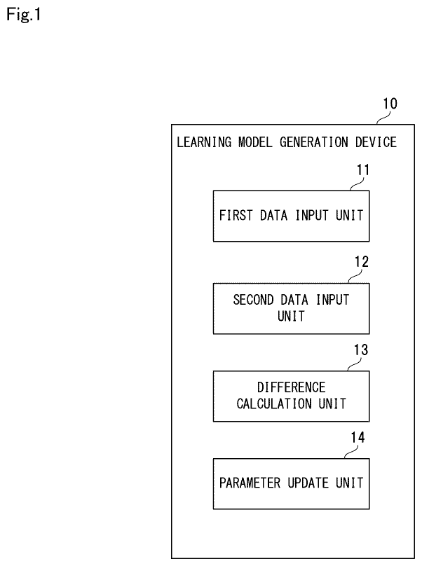

Hereinafter, an example of a learning model generation device, a learning model generation method, and a program will be described with reference to FIGS. 1 to 6.

### [Device Configuration]

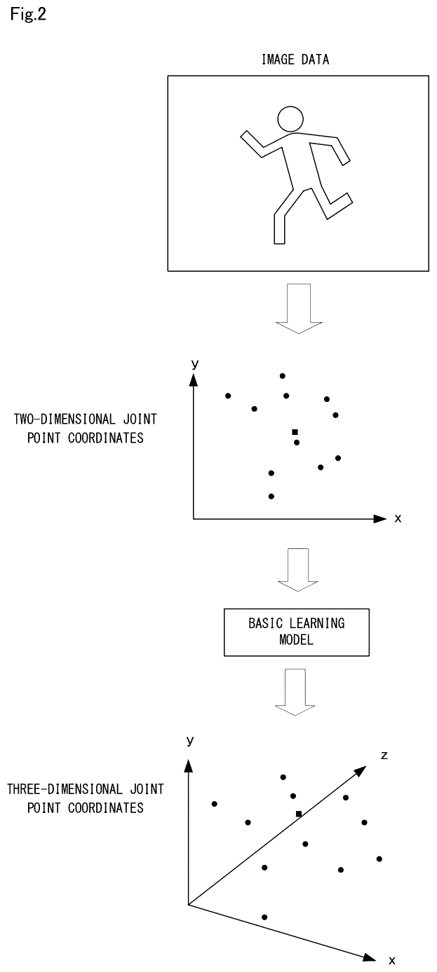

First, a schematic configuration of an example of a learning model generation device will be described with reference to FIGS. 1 and 2. FIG. 1 is a configuration diagram illustrating a schematic configuration of an example of the learning model generation device. FIG. 2 is a diagram for describing a function of a basic learning model.

A learning model generation device 10 illustrated in FIG. 1 is a device for generating a learning model that receives two-dimensional human joint point coordinates as an input, and outputs corresponding three-dimensional human joint point coordinates. As illustrated in FIG. 1, the learning model generation device 10 includes a first data input unit 11, a second data input unit 12, a difference calculation unit 13, and a parameter update unit 14.

The first data input unit 11 inputs the first sample data to the basic learning model. The basic learning model is a learning model that has been trained through machine learning on a relationship between two-dimensional joint point coordinates and three-dimensional joint point coordinates. The second data input unit 12 inputs second sample data having a difference from the first sample data to a learning model to be updated (hereinafter referred to as an “update model”).

The basic learning model will be described with reference to FIG. 2. As illustrated in FIG. 2, when two-dimensional joint point coordinates of a human joint point are input to the basic learning model, the basic learning model outputs three-dimensional joint point coordinates of a corresponding human joint point. Note that the two-dimensional joint point coordinates are extracted in advance from human image data using, for example, a machine learning model that has been trained through machine learning on a relationship between image feature quantities and joint points.

The difference calculation unit 13 calculates a difference between the intermediate feature quantity of the basic learning model when the first sample data is input and the intermediate feature quantity of the learning model to be updated when the second sample data is input. The parameter update unit 14 updates the parameters of the learning model to be updated using the difference calculated by the difference calculation unit 13.

As described above, in Example Embodiment 1, since the parameters of the update model are updated by using the difference between the intermediate feature quantity of the basic learning model and the intermediate feature quantity of the update model, machine learning in consideration of noise is performed in the update model. Therefore, according to the update model obtained in Example Embodiment 1, it is possible to improve the detection accuracy in estimating the three-dimensional coordinates of each joint point from the two-dimensional coordinates of each joint.

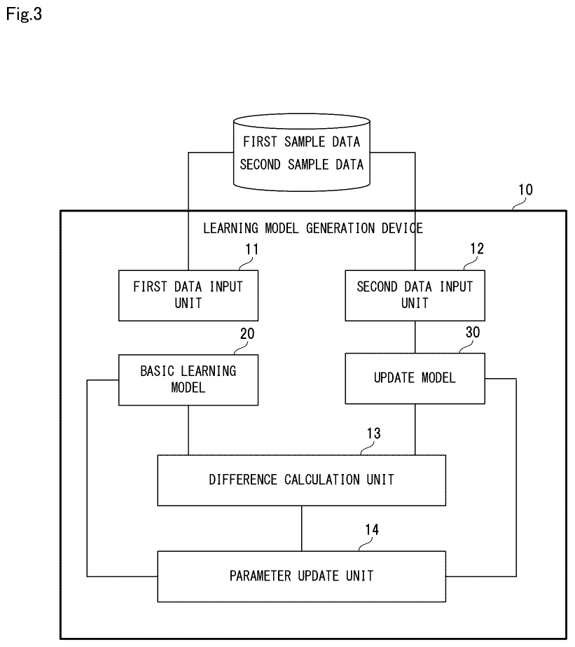

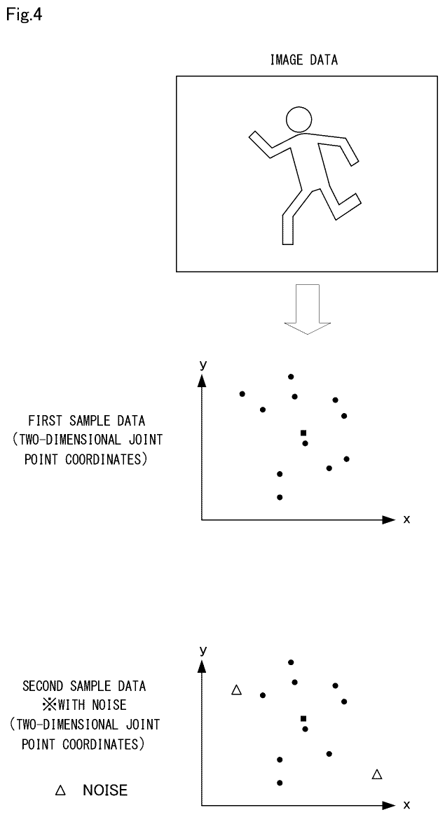

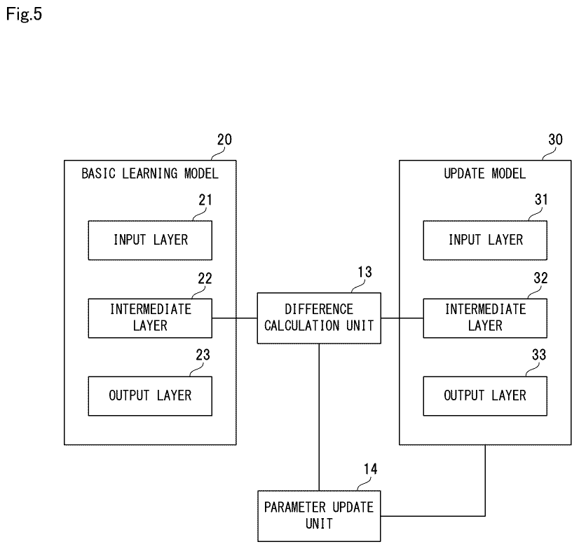

Next, a configuration and a function of an example of the learning model generation device will be specifically described with reference to FIGS. 3 to 5 in addition to FIGS. 1 and 2. FIG. 3 is a configuration diagram specifically illustrating a configuration of an example of the learning model generation device. FIG. 4 is an explanatory diagram for describing the first sample data and the second sample data. FIG. 5 is a configuration diagram illustrating an example of a configuration of a basic learning model and an update model.

As illustrated in FIG. 3, a basic learning model 20 and an update model 30 are implemented in the learning model generation device 10. In Example Embodiment 1, the basic learning model 20 and the update model 30 are, for example, neural networks. In addition, the basic learning model 20 and the update model 30 are actually implemented by a machine learning program executed on a computer. Note that the basic learning model 20 and the update model 30 may be constructed outside the learning model generation device 10.

As illustrated in FIG. 4, the first sample data is two-dimensional joint point data including two-dimensional joint point coordinates detected from an image of a specific person. On the other hand, the second sample data is also two-dimensional joint point data including two-dimensional joint point coordinates detected from the image of a specific person. However, as illustrated in FIG. 4, the second sample data differs from the first sample data in the values of all or some of the joint point coordinates. That is, the second sample data is data in which noise is added to the first sample data.

In addition, in the example of FIG. 2, the second data input unit 12 acquires the second sample data prepared in advance from the outside, but Example Embodiment 1 is not limited to this aspect. In Example Embodiment 1, the second data input unit 12 can also generate the second sample data by acquiring the first sample data and adding noise to the acquired first sample data.

Specifically, the second data input unit 12 generates the second sample data by randomly selecting any of the joint points of the first sample data, and randomly moving the position of the selected joint point to another position (refer to FIG. 4).

As illustrated in FIG. 5, in Example Embodiment 1, the basic learning model 20 and the update model 30 are neural networks as described above. The basic learning model 20 includes, for example, an input layer 21, an intermediate layer (hidden layer) 22, and an output layer 23. Similarly, the update model 30 also includes an input layer 31, an intermediate layer (hidden layer) 32, and an output layer 33.

In Example Embodiment 1, the difference calculation unit 13 acquires the intermediate feature quantity from the intermediate layer 22 of the basic learning model 20, and further acquires the intermediate feature quantity from the intermediate layer 32 of the update model 30. Then, the difference calculation unit 13 calculates a difference between the intermediate feature quantity acquired from the intermediate layer 22 and the intermediate feature quantity acquired from the intermediate layer 32.

In Example Embodiment 1, when the difference is calculated by the difference calculation unit 13, the parameter update unit 14 updates the parameters of the update model 30, that is, the weight of each node such that the calculated difference becomes small.

### [Device Operation]

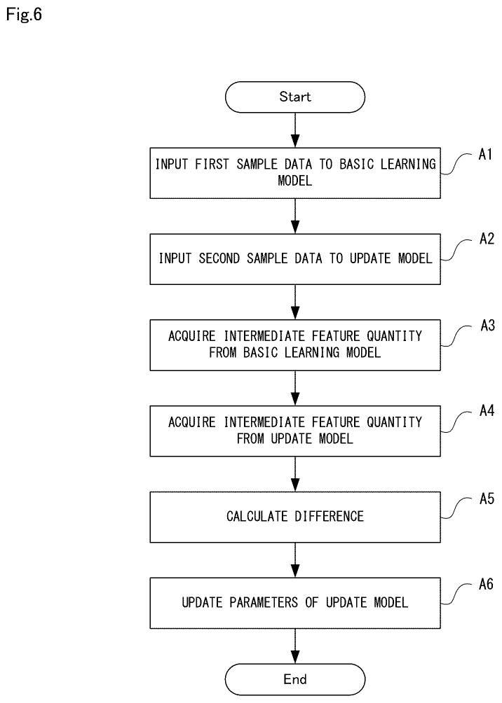

Next, an example of the operation of the learning model generation device 10 will be described with reference to FIG. 6. FIG. 6 is a flowchart illustrating an example of an operation of the learning model generation device. FIGS. 1 to 5 will be appropriately referred to in the following description. Furthermore, in Example Embodiment 1, the learning model generation method is performed by operating the learning model generation device. Therefore, the description of the learning model generation method in Example Embodiment 1 is replaced with the following description of the operation of the learning model generation device 10.

As illustrated in FIG. 6, the first data input unit 11 first acquires the first sample data, and inputs the acquired first sample data to the basic learning model 20 (step A1).

Next, the second data input unit 12 acquires the second sample data having a difference from the first sample data, and inputs the acquired second sample data to the update model (step A2).

In Example Embodiment 1, in step A2, the second data input unit 12 may acquire the first sample data instead of the second sample data, and generate the second sample data from the acquired first sample data.

Next, the difference calculation unit 13 acquires the intermediate feature quantity from the intermediate layer 22 of the basic learning model 20 (step A3). The difference calculation unit 13 also acquires the intermediate feature quantity from the intermediate layer 32 of the update model 30 (step A4).

Next, the difference calculation unit 13 calculates a difference between the intermediate feature quantity acquired from the intermediate layer 22 in step A3 and the intermediate feature quantity acquired from the intermediate layer 32 in step A4 (step A5).

Thereafter, the parameter update unit 14 acquires the difference calculated by the difference calculation unit 13 in step A5, and updates the parameters of the update model 30 to reduce the difference (step A6). In Example Embodiment 1, the update model is completed by updating the parameters of the update model. That is, the update model is generated by updating the parameters of the update model.

Steps A1 to A6 are repeatedly executed as many times as the first sample data and the second sample data. Note that the plurality of pieces of first sample data and the plurality of pieces of second sample data input in this case preferably have no time difference. When the time difference is small, the noise becomes more prominent, and its correction becomes easier.

As described above, in Example Embodiment 1, a learning model that has been trained through machine learning by training data with less noise is used as the basic learning model 20. In addition, the parameters of the update model 30 are updated using the difference between the intermediate feature quantity of the basic learning model 20 and the intermediate feature quantity of the update model 30. As a result, the parameters of the update model 30 are updated in consideration of the noise included in the second sample data. Therefore, according to the update model 30 in which the parameters are updated in Example Embodiment 1, it is possible to improve the detection accuracy in estimating the three-dimensional coordinates of each joint point from the two-dimensional coordinates of each joint.

### [Modification]

Here, a modification of Example Embodiment 1 will be described. In the modification, as the above-described image of a specific person, an image of each of consecutive frames of moving image data in which a person is captured is used. In this case, each of the first sample data and the second sample data is created for each frame of the moving image data.

Then, the first data input unit 11 inputs N pieces of first sample data to the basic learning model 20 along the time series of frames. In addition, the second data input unit 12 inputs N pieces of second sample data to the update model 30 in synchronization with the first data input unit 11. N is any integer.

Furthermore, in this case, the basic learning model 20 and the update model 30 may output N pieces of output data corresponding to each sample data with respect to the N pieces of sample data, or may output only one piece of output data (for example, output data corresponding to the center frame).

The difference calculation unit 13 acquires the intermediate feature quantity from the intermediate layer 22 of the basic learning model 20 when the N pieces of first sample data are input. The difference calculation unit 13 also acquires the intermediate feature quantity from the intermediate layer 32 of the update model 30 when the N pieces of second sample data are input. Then, the difference calculation unit 13 calculates a difference between the intermediate feature quantity acquired from the intermediate layer 22 and the intermediate feature quantity acquired from the intermediate layer 32.

Thereafter, similarly to the case where the moving image data is not used, the parameter update unit 14 updates the parameters of the update model 30 such that the difference calculated by the difference calculation unit 13 becomes small.

As described above, in the modification, a plurality of consecutive frames is input to each learning model as one input. Then, in the second sample data, there is a possibility that a frame in which noise occurs and a frame in which no noise occurs are mixed. In this case, in the update model 30, since the complementation of the noise occurs between the frames, the correction of the noise becomes more noticeable by the update of the parameters.

### [Program]

The program in Example Embodiment 1 may be a program that causes a computer to execute steps A1 to A6 illustrated in FIG. 6. By installing and executing this program in the computer, the learning model generation device 10 and the learning model generation method according to Example Embodiment 1 can be implemented. In this case, the processor of the computer functions as the first data input unit 11, the second data input unit 12, the difference calculation unit 13, and the parameter update unit 14, and performs processing. Examples of the computer include a smartphone and a tablet terminal device in addition to a general-purpose PC.

The program in Example Embodiment 1 may be executed by a computer system constructed by a plurality of computers. In this case, for example, each computer may function as any of the first data input unit 11, the second data input unit 12, the difference calculation unit 13, and the parameter update unit 14.

### Example Embodiment 2

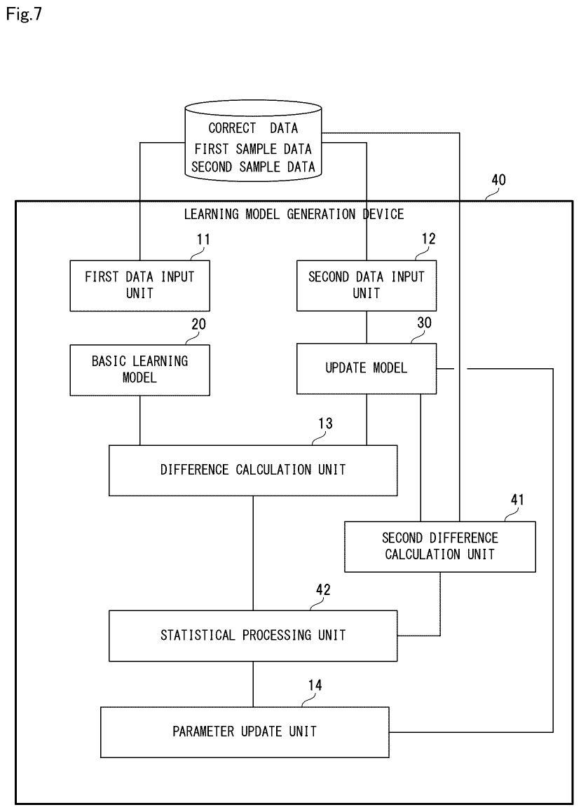

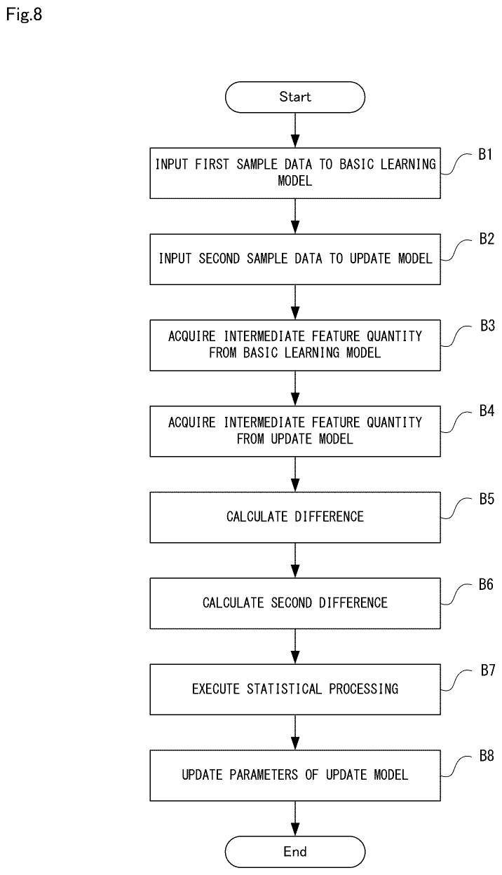

Hereinafter, another example of the learning model generation device, the learning model generation method, and the program will be described with reference to FIGS. 7 and 8.

### [Device Configuration]

First, a configuration of another example of the learning model generation device will be described with reference to FIG. 7. FIG. 7 is a configuration diagram illustrating a configuration of another example of the learning model generation device.

Similarly to Example Embodiment 1, a learning model generation device 40 illustrated in FIG. 7 is a device for generating a learning model that receives two-dimensional human joint point coordinates as an input, and outputs corresponding three-dimensional human joint point coordinates.

As illustrated in FIG. 7, similarly to the learning model generation device 10 illustrated in Example Embodiment 1, the learning model generation device 40 includes the first data input unit 11, the second data input unit 12, the difference calculation unit 13, and the parameter update unit 14.

However, unlike the learning model generation device 10 described in Example Embodiment 1, the learning model generation device 40 also includes a second difference calculation unit 41 and a statistical processing unit 42 in addition to the above-described configuration. Hereinafter, differences from Example Embodiment 1 will be mainly described.

The second difference calculation unit 41 calculates a difference between the correct data and the output data of the update model 30 when the second sample data is input as a second difference. The correct data is data including three-dimensional joint point coordinates that are correct for the first sample data. That is, the correct data is data configured by actual three-dimensional coordinates of joint points of a person in the image from which the first and second sample data are extracted.

The statistical processing unit 42 executes statistical processing by using the difference calculated by the difference calculation unit 13 and the second difference calculated by the second difference calculation unit 41. The statistical processing in this case is not particularly limited. A specific example of the statistical processing is a weighted average.

In Example Embodiment 2, the parameter update unit 14 updates the parameters of the update model 30 based on the result of the statistical processing by the statistical processing unit 42. Specifically, the parameter update unit 14 updates the parameters of the update model 30, that is, the weight such that the value (for example, the weighted average value) obtained by the statistical processing by the statistical processing unit 42 becomes small.

Also in Example Embodiment 2, the first sample data and the second sample data may be input for each frame. In this case, the calculation of the difference by the difference calculation unit 13, the calculation of the second difference by the second difference calculation unit 41, the statistical processing by the statistical processing unit 42, and the update by the parameter update unit 14 are performed for each frame.

### [Device Operation]

Next, another example of the operation of the learning model generation device 40 will be described with reference to FIG. 8. FIG. 8 is a flowchart illustrating another example of the operation of the learning model generation device. FIG. 7 will be appropriately referred to in the following description. In Example Embodiment 2, the learning model generation method is performed by operating the learning model generation device. Therefore, the description of the learning model generation method in Example Embodiment 2 is replaced with the following description of the operation of the learning model generation device 4.

As illustrated in FIG. 8, the first data input unit 11 first acquires the first sample data, and inputs the acquired first sample data to the basic learning model 20 (step B1).

Next, the second data input unit 12 acquires second sample data having a difference from the first sample data, and inputs the acquired second sample data to the update model (step B2).

Next, the difference calculation unit 13 acquires the intermediate feature quantity from the intermediate layer 22 of the basic learning model 20 (step B3). The difference calculation unit 13 also acquires the intermediate feature quantity from the intermediate layer 32 of the update model 30 (step B4).

Next, the difference calculation unit 13 calculates a difference between the intermediate feature quantity acquired from the intermediate layer 22 in step A3 and the intermediate feature quantity acquired from the intermediate layer 32 in step A4 (step B5). Note that steps B1 to B5 described above are substantially the same as steps Al to A5 illustrated in FIG. 6 in Example Embodiment 1.

Next, in Example Embodiment 2, the second difference calculation unit 41 acquires the correct data from the outside, acquires the output data when the second sample data is input from the update model 30, and calculates the difference between the correct data and the output data of the update model 30 as the second difference (step B6).

Next, the statistical processing unit 42 executes statistical processing by using the difference calculated in step B5 and the second difference calculated in step B6 (step B7).

Thereafter, the parameter update unit 14 updates the parameters of the update model 30 based on the result of the statistical processing in step B7 (step B8).

Steps B1 to B8 are repeatedly executed by the number of pieces of the first sample data and the number of pieces of the second sample data, similarly to Example Embodiment 1. Also in Example Embodiment 2, in a case where the first sample data and the second sample data are obtained for each frame of the moving image data, steps B1 to B8 are repeatedly executed for each frame.

As described above, in Example Embodiment 2, the parameters of the update model 30 are updated by using the difference (second difference) between the output data of the update model and the correct data. As a result, in Example Embodiment 2, the noise included in the second sample data is further considered. According to Example Embodiment 2, it is possible to further improve detection accuracy in estimating three-dimensional coordinates of each joint point from the two-dimensional coordinates of each joint.

Also in Example Embodiment 2, as described in the modification of Example Embodiment 1, images of each of consecutive frames of moving image data in which a person is captured may be used as the above-described image of a specific person. In this case, also in Example Embodiment 2, the first data input unit 11 inputs N pieces of first sample data to the basic learning model 20 along the time series of frames. In addition, the second data input unit 12 inputs N pieces of second sample data to the update model 30 in synchronization with the first data input unit 11.

Furthermore, in this case, the basic learning model 20 and the update model 30 may output N pieces of output data corresponding to each sample data with respect to the N pieces of sample data, or may output only one piece of output data (for example, output data corresponding to the center frame).

Then, in a case where the former N pieces of output data are output, unlike step B6 described above, the second difference calculation unit 41 calculates N pieces of difference between the correct data and the output data of the update model 30 for each frame. Thereafter, the second difference calculation unit 41 performs statistical processing such as an arithmetic average and a weighted average using each calculated difference to calculate a single (scalar) loss, and sets this as the second difference.

In the latter case where only one piece of output data is output, the second difference calculation unit 41 calculates the difference between the correct data and the output data of the update model 30 similar to step B6 described above, and sets the calculated difference as the second difference.

### [Program]

The program in Example Embodiment 2 may be a program that causes a computer to execute steps B1 to B8 illustrated in FIG. 8. By installing and executing this program in the computer, the learning model generation device 40 and the learning model generation method according to Example Embodiment 2 can be implemented. In this case, the processor of the computer functions as the first data input unit 11, the second data input unit 12, the difference calculation unit 13, the parameter update unit 14, the second difference calculation unit 41, and the statistical processing unit 42, and performs processing. Examples of the computer include a smartphone and a tablet terminal device in addition to a general-purpose PC.

The program in Example Embodiment 2 may be executed by a computer system constructed by a plurality of computers. In this case, for example, each computer may function as any of the first data input unit 11, the second data input unit 12, the difference calculation unit 13, the parameter update unit 14, the second difference calculation unit 41, and the statistical processing unit 42.

### Example Embodiment 3

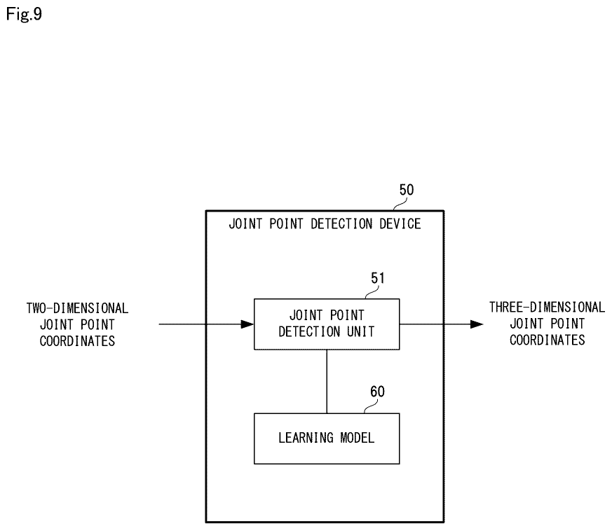

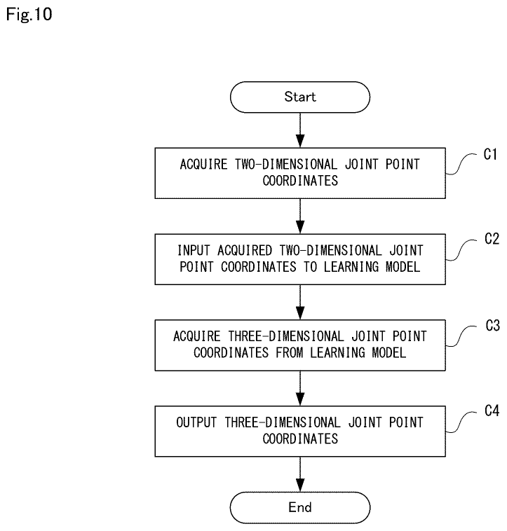

Next, an example of a joint point detection device, a joint point detection method, and a program will be described with reference to FIGS. 9 and 10.

### [Device Configuration]

First, a configuration of an example of the joint point detection device will be described with reference to FIG. 9. FIG. 9 is a configuration diagram illustrating a configuration of an example of the joint point detection device.

A joint point detection device 50 illustrated in FIG. 9 is a device that detects three-dimensional human joint point coordinates corresponding to the two-dimensional human joint point coordinates from the two-dimensional human joint point coordinates. As illustrated in FIG. 9, the joint point detection device 50 includes a joint point detection unit 51. The joint point detection unit 51 inputs the two-dimensional joint point coordinates of a person to the learning model 60 and detects the three-dimensional joint point coordinates of a person.

The learning model 60 is a learning model that has been trained through machine learning on a relationship between the two-dimensional joint point coordinates and the three-dimensional joint point coordinates. The parameters of the learning model 60 are updated by using a difference between the first intermediate feature quantity and the second intermediate feature quantity. In addition, the first intermediate feature quantity is an intermediate feature quantity when the first sample data is input to the basic learning model that has been trained through machine learning on the relationship between the two-dimensional joint point coordinates and the three-dimensional joint point coordinates. The second intermediate feature quantity is an intermediate feature quantity when the second sample data having a difference from the first sample data is input to the learning model 60.

Specifically, in Example Embodiment 3, the learning model 60 is a neural network, and is the learning model generated by the learning model generation device according to Example Embodiment 1 or 2, that is, the update model 30 (refer to FIGS. 1, 3, and 7). The learning model 60 is also implemented by a machine learning program executed on a computer.

As described above, the joint point detection device 50 detects the three-dimensional joint point coordinates of a person using the learning model generated by the learning model generation device according to Example Embodiment 1 or 2.

### [Device Operation]

Next, an example of the operation of the joint point detection device 50 will be described with reference to FIG. 10. FIG. 10 is a flowchart illustrating an example of the operation of the joint point detection device 50. FIG. 9 will be appropriately referred to in the following description. In Example Embodiment 3, the joint point detection method is performed by operating the joint point detection device 50. Therefore, the description of the joint point detection method in Example Embodiment 3 is replaced with the following description of the operation of the joint point detection device 50.

As illustrated in FIG. 10, first, the joint point detection unit 51 acquires two-dimensional coordinates of joint points of a person to be input data (step C1). Next, the joint point detection unit 51 inputs the two-dimensional coordinates acquired in step C1 to the learning model 60 (step C2).

Next, the joint point detection unit 51 acquires the three-dimensional coordinates of the joint points output by the learning model 60 (step C3). In Example Embodiment 3, the three-dimensional coordinates of the joint points of a person are detected in step C3.

Next, the joint point detection unit 51 outputs the three-dimensional coordinates of the joint points acquired in step C3 to the outside (step C4).

As described above, according to Example Embodiment 3, the three-dimensional coordinates of the joint points can be detected using the learning model generated in Example Embodiment 1 or 2. Therefore, the three-dimensional coordinates of the joint points are detected in consideration of the noise of the two-dimensional coordinates serving as the input data, and have become values with high accuracy.

### [Program]

The program in Example Embodiment 3 may be a program that causes a computer to execute steps C1 to C4 illustrated in FIG. 10. By installing and executing this program in the computer, the joint point detection device 50 and the joint point detection method according to the present example embodiment can be implemented. In this case, the processor of the computer functions as the joint point detection unit 51 and performs processing. Examples of the computer include a smartphone and a tablet terminal device in addition to a general-purpose PC.

The program in Example Embodiment 3 may be executed by a computer system constructed by a plurality of computers. In this case, a plurality of computers functions as the joint point detection unit 51.

### [Physical Configuration]

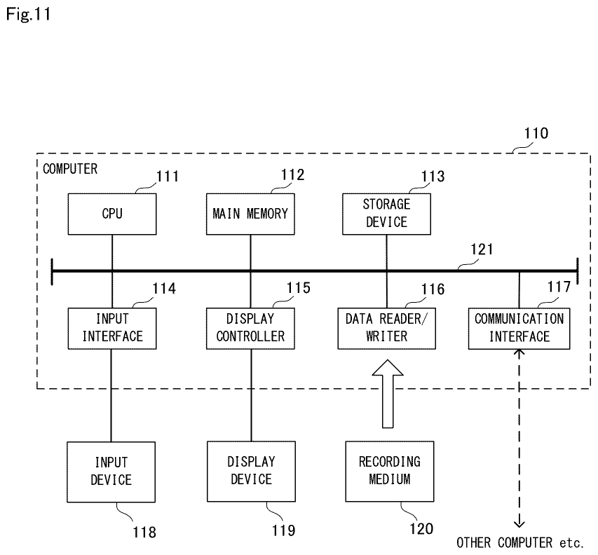

Here, the computer that implements the learning model generation device and the joint point detection device by executing a program in Example Embodiments 1 to 3 will be described with reference to FIG. 11. FIG. 11 is a block diagram illustrating an example of the computer that implements the learning model generation device and the joint point detection device.

As illustrated in FIG. 11, a computer 110 includes a central processing unit (CPU) 111, a main memory 112, a storage device 113, an input interface 114, a display controller 115, a data reader/writer 116, and a communication interface 117. These units are data-communicably connected to each other via a bus 121.

Furthermore, the computer 110 may include a graphics processing unit (GPU) or a field-programmable gate array (FPGA) in addition to the CPU 111 or instead of the CPU 111. In this aspect, the GPU or the FPGA can execute the program in the example embodiment.

The CPU 111 develops the program according to the example embodiment, which is stored in the storage device 113 and configured by a code group, in the main memory 112, and executes each code in a predetermined order to perform various operations. The main memory 112 is typically a volatile storage device such as a dynamic random access memory (DRAM).

In addition, the program in Example Embodiments 1 to 3 is provided in a state of being stored in a computer-readable recording medium 120. Note that the program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and the input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as Compact Flash (CF) (registered trademark) and a secure digital (SD), a magnetic recording medium such as a flexible disk, and an optical recording medium such as a compact disk read only memory (CD-ROM).

Note that the learning model generation device and the joint point detection device according to the example embodiment can also be implemented by using hardware corresponding to each unit, for example, an electronic circuit, instead of a computer in which a program is installed. Furthermore, a part of the learning model generation device and the joint point detection device according to the example embodiment may be implemented by a program, and the remaining part may be implemented by hardware. In the example embodiment, the computer is not limited to the computer illustrated in FIG. 11.

Some or all of the above-described example embodiments can be expressed by (Supplementary Note 1) to (Supplementary Note 18) described below, but are not limited to the following description.

### (Supplementary Note 1)

A learning model generation device including:
a first data input unit for inputting first sample data to a basic learning model that has been trained through machine learning on a relationship between two-dimensional joint point coordinates and three-dimensional joint point coordinates;
a second data input unit for inputting second sample data having differences from the first sample data to a learning model to be updated;
a difference calculation unit for calculating a difference between an intermediate feature quantity of the basic learning model when the first sample data is input and an intermediate feature quantity of the learning model to be updated when the second sample data is input; and
a parameter update unit for updating parameters of the learning model to be updated by using the calculated difference.

### (Supplementary Note 2)

The learning model generation device according to Supplementary Note 1, in which
the first sample data includes two-dimensional joint point coordinates detected from an image of a specific person, and
the second sample data includes two-dimensional joint point coordinates detected from the image of a specific person, and values of all or some of the joint point coordinates are different from values of the first sample data.

### (Supplementary Note 3)

The learning model generation device according to Supplementary Note 2, further including:
a second difference calculation unit for calculating, as a second difference, a difference between correct data including three-dimensional joint point coordinates that are correct for the first sample data and output data of the learning model to be updated when the second sample data is input; and
a statistical processing unit for executing statistical processing by using the difference calculated by the difference calculation unit and the second difference calculated by the second difference calculation unit, in which the parameter update unit updates parameters of the learning model to be updated based on a result of the statistical processing.

### (Supplementary Note 4)

The learning model generation device according to Supplementary Note 2 or 3, in which
the image of a specific person is an image of each of consecutive frames of moving image data in which a person is captured, and each of the first sample data and the second sample data includes a plurality of the frames,
the first data input unit inputs a plurality of pieces of the first sample data along a time series of the frame, and
the second data input unit inputs a plurality of pieces of the second sample data in synchronization with the first data input unit.

### (Supplementary Note 5)

The learning model generation device according to Supplementary Note 1, in which
the second data input unit generates the second sample data by adding noise to the first sample data, and inputs the generated second sample data to the basic learning model.

### (Supplementary Note 6)

A joint point detection device including:
a joint point detection unit for inputting two-dimensional joint point coordinates of a person to a learning model and detecting three-dimensional joint point coordinates of the person, in which
parameters of the learning model are updated using the difference between
intermediate feature quantities when first sample data are input to a basic learning model that has been trained through machine learning on a relationship between two-dimensional joint point coordinates and three-dimensional joint point coordinates, and
intermediate feature quantities when second sample data having differences from the first sample data are input to the learning model.

### (Supplementary Note 7)

A learning model generation method including:
a first data input step of inputting first sample data to a basic learning model that has been trained through machine learning on a relationship between two-dimensional joint point coordinates and three-dimensional joint point coordinates;
a second data input step of inputting second sample data having differences from the first sample data to a learning model to be updated;
a difference calculation step of calculating a difference between an intermediate feature quantity of the basic learning model when the first sample data is input and an intermediate feature quantity of the learning model to be updated when the second sample data is input; and
a parameter update step of updating parameters of the learning model to be updated by using the calculated difference.

### (Supplementary Note 8)

The learning model generation method according to Supplementary Note 7, in which
the first sample data includes two-dimensional joint point coordinates detected from an image of a specific person, and
the second sample data includes two-dimensional joint point coordinates detected from the image of a specific person, and values of all or some of the joint point coordinates are different from values of the first sample data.

### (Supplementary Note 9)

The learning model generation method according to Supplementary Note 8, further including:
a second difference calculation step of calculating, as a second difference, a difference between correct data including three-dimensional joint point coordinates that are correct for the first sample data and output data of the learning model to be updated when the second sample data is input; and
a statistical processing step of executing statistical processing by using the difference calculated in the difference calculation step and the second difference calculated in the second difference calculation step, in which parameters of the learning model to be updated are updated based on a result of the statistical processing, in the parameter update step.

### (Supplementary Note 10)

The learning model generation method according to Supplementary Note 8 or 9, in which
the image of a specific person is an image of each of consecutive frames of moving image data in which a person is captured, and each of the first sample data and the second sample data includes a plurality of the frames,
in the first data input step, a plurality of pieces of the first sample data is input along a time series of the frame, and
in the second data input step, a plurality of pieces of the second sample data is input in synchronization with the first data input step.

### (Supplementary Note 11)

The learning model generation method according to Supplementary Note 7, in which
in the second data input step, the second sample data is generated by adding noise to the first sample data, and the generated second sample data is input to the basic learning model.

### (Supplementary Note 12)

A joint point detection method including:
a joint point detection step of inputting two-dimensional joint point coordinates of a person to a learning model and detecting three-dimensional joint point coordinates of the person, in which
parameters of the learning model are updated using the difference between
intermediate feature quantities when first sample data are input to a basic learning model that has been trained through machine learning on a relationship between two-dimensional joint point coordinates and three-dimensional joint point coordinates, and
intermediate feature quantities when second sample data having differences from the first sample data are input to the learning model.

### (Supplementary Note 13)

A computer-readable recording medium storing a program including instructions that cause a computer to execute
a first data input step of inputting first sample data to a basic learning model that has been trained through machine learning on a relationship between two-dimensional joint point coordinates and three-dimensional joint point coordinates,
a second data input step of inputting second sample data having differences from the first sample data to a learning model to be updated,
a difference calculation step of calculating a difference between an intermediate feature quantity of the basic learning model when the first sample data is input and an intermediate feature quantity of the learning model to be updated when the second sample data is input, and
a parameter update step of updating parameters of the learning model to be updated by using the calculated difference.

### (Supplementary Note 14)

The computer-readable recording medium according to Supplementary Note 13, in which
the first sample data includes two-dimensional joint point coordinates detected from an image of a specific person, and
the second sample data includes two-dimensional joint point coordinates detected from the image of a specific person, and values of all or some of the joint point coordinates are different from values of the first sample data.

### (Supplementary Note 15)

The computer-readable recording medium according to Supplementary Note 14, in which
the program further including instructions that cause a computer to execute a second difference calculation step of calculating, as a second difference, a difference between correct data including three-dimensional joint point coordinates that are correct for the first sample data and output data of the learning model to be updated when the second sample data is input, and
a statistical processing step of executing statistical processing by using the difference calculated in the difference calculation step and the second difference calculated in the second difference calculation step, in which
parameters of the learning model to be updated are updated based on a result of the statistical processing, in the parameter update step.

### (Supplementary Note 16)

The computer-readable recording medium according to Supplementary Note 14 or 15, in which
the image of a specific person is an image of each of consecutive frames of moving image data in which a person is captured, and each of the first sample data and the second sample data includes a plurality of the frames,
in the first data input step, a plurality of pieces of the first sample data is input along a time series of the frame, and
in the second data input step, a plurality of pieces of the second sample data is input in synchronization with the first data input step.

### (Supplementary Note 17)

The computer-readable recording medium according to Supplementary Note 13, in which
in the second data input step, the second sample data is generated by adding noise to the first sample data, and the generated second sample data is input to the basic learning model.

### (Supplementary Note 18)

A computer-readable recording medium storing a program including instructions that cause a computer to
execute a joint point detection step of inputting two-dimensional joint point coordinates of a person to a learning model and detecting three-dimensional joint point coordinates of the person, in which
parameters of the learning model are updated using the difference between
intermediate feature quantities when first sample data are input to a basic learning model that has been trained through machine learning on a relationship between two-dimensional joint point coordinates and three-dimensional joint point coordinates, and
intermediate feature quantities when second sample data having differences from the first sample data are input to the learning model.

While the present disclosure has been particularly shown and described with reference to example embodiments thereof, the present disclosure is not limited to the above example embodiments. It will be understood by those of ordinary skill in the art that various changes in form and details may be made therein without departing from the spirit and scope of the present disclosure as defined by the claims.

This application is based upon and claims the benefit of priority from Japanese patent application No. 2022-211356, filed on Dec. 28, 2022, the disclosure of which is incorporated herein in its entirety by reference.

### INDUSTRIAL APPLICABILITY

As described above, according to the present disclosure, it is possible to improve detection accuracy in estimating three-dimensional coordinates of each joint point from two-dimensional coordinates of each joint. The present disclosure is useful for a system that is required to estimate human poses from an image, for example, a video monitoring system.

### REFERENCE SIGNS LIST

10 Learning model generation device (Example Embodiment 1)
11 First data input unit
12 Second data input unit
13 Difference calculation unit
14 Parameter update unit
20 Basic learning model
21 Input layer
22 Intermediate layer (hidden layer)
23 Output layer
30 Update model
31 Input layer
32 Intermediate layer (hidden layer)
33 Output layer
40 Learning model generation device (Example Embodiment 2)
41 Second difference calculation unit
42 Statistical processing unit
50 Joint point detection device
51 Joint point detection unit
60 Learning model
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A learning model generation device comprising:
at least one memory storing instructions; and
at least one processor configured to execute the instructions to:
input first sample data to a basic learning model that has been trained through machine learning on a relationship between two-dimensional joint point coordinates and three-dimensional joint point coordinates;
input second sample data having differences from the first sample data to a learning model to be updated;
calculate a difference between an intermediate feature quantity of the basic learning model when the first sample data is input and an intermediate feature quantity of the learning model to be updated when the second sample data is input; and
update parameters of the learning model to be updated by using the calculated difference.

2. The learning model generation device according to claim 1, wherein
the first sample data includes two-dimensional joint point coordinates detected from an image of a specific person, and
the second sample data includes two-dimensional joint point coordinates detected from the image of a specific person, and values of all or some of the joint point coordinates are different from values of the first sample data.

3. The learning model generation device according to claim 2, wherein
at least one processor calculates
as a second difference, a difference between correct data including three-dimensional joint point coordinates that are correct for the first sample data and output data of the learning model to be updated when the second sample data is input; and
executes statistical processing by using the difference calculated and the second difference calculated, wherein
updates parameters of the learning model to be updated based on a result of the statistical processing.

4. The learning model generation device according to claim 2, wherein
the image of a specific person is an image of each of consecutive frames of moving image data in which a person is captured, and each of the first sample data and the second sample data includes a plurality of the frames,
at least one processor inputs a plurality of pieces of the first sample data along a time series of the frame, and
at least one processor inputs a plurality of pieces of the second sample data in synchronization with the first data input means.

5. The learning model generation device according to claim 1, wherein
at least one processor generates the second sample data by adding noise to the first sample data, and inputs the generated second sample data to the basic learning model.

6. (canceled)

7. A learning model generation method comprising:
inputting first sample data to a basic learning model that has been trained through machine learning on a relationship between two-dimensional joint point coordinates and three-dimensional joint point coordinates;
inputting second sample data having differences from the first sample data to a learning model to be updated;
calculating a difference between an intermediate feature quantity of the basic learning model when the first sample data is input and an intermediate feature quantity of the learning model to be updated when the second sample data is input; and
updating parameters of the learning model to be updated by using the calculated difference.

8. The learning model generation method according to claim 7, wherein
the first sample data includes two-dimensional joint point coordinates detected from an image of a specific person, and
the second sample data includes two-dimensional joint point coordinates detected from the image of a specific person, and values of all or some of the joint point coordinates are different from values of the first sample data.

9. The learning model generation method according to claim 8, further comprising:
calculating, as a second difference, a difference between correct data including three-dimensional joint point coordinates that are correct for the first sample data and output data of the learning model to be updated when the second sample data is input;
executing statistical processing by using the difference calculated in the difference calculation step and the second difference calculated in the second difference calculation step; and
updating parameters of the learning model to be updated based on a result of the statistical processing, in the update of the parameters.

10. The learning model generation method according to claim 8, wherein
the image of a specific person is an image of each of consecutive frames of moving image data in which a person is captured, and each of the first sample data and the second sample data includes a plurality of the frames,
in the input of the first data, a plurality of pieces of the first sample data is input along a time series of the frame, and
in the input of the second data, a plurality of pieces of the second sample data is input in synchronization with the first data input step.

11. The learning model generation method according to claim 7, wherein
in the input of the second data, the second sample data is generated by adding noise to the first sample data, and the generated second sample data is input to the basic learning model.

12. (canceled)

13. A non-transitory computer-readable recording medium storing a program including instructions that cause a computer to
input first sample data to a basic learning model that has been trained through machine learning on a relationship between two-dimensional joint point coordinates and three-dimensional joint point coordinates,
input second sample data having differences from the first sample data to a learning model to be updated,
calculate a difference between an intermediate feature quantity of the basic learning model when the first sample data is input and an intermediate feature quantity of the learning model to be updated when the second sample data is input, and
update parameters of the learning model to be updated by using the calculated difference.

14. The non-transitory computer-readable recording medium according to claim 13, wherein
the first sample data includes two-dimensional joint point coordinates detected from an image of a specific person, and
the second sample data includes two-dimensional joint point coordinates detected from the image of a specific person, and values of all or some of the joint point coordinates are different from values of the first sample data.

15. The non-transitory computer-readable recording medium according to claim 14, wherein
the program includes instructions that further cause a computer to
calculate, as a second difference, a difference between correct data including three-dimensional joint point coordinates that are correct for the first sample data and output data of the learning model to be updated when the second sample data is input, and
execute statistical processing by using the difference calculated in the difference calculation step and the second difference calculated in the second difference calculation step, wherein
parameters of the learning model to be updated are updated based on a result of the statistical processing, in the update of the parameters.

16. The non-transitory computer-readable recording medium according to claim 14, wherein
the image of a specific person is an image of each of consecutive frames of moving image data in which a person is captured, and each of the first sample data and the second sample data includes a plurality of the frames,
in the input of the first data, a plurality of pieces of the first sample data is input along a time series of the frame, and
in the input of the second data, a plurality of pieces of the second sample data is input in synchronization with the first data input step.

17. The non-transitory computer-readable recording medium according to claim 13, wherein
in the input of the second data, the second sample data is generated by adding noise to the first sample data, and the generated second sample data is input to the basic learning model.

18. (canceled)
